(19) United States
(12) Patent Application Publication
(10) Pub. No.: US 2003/0216127 A1
(43) Pub. Date: Nov. 20, 2003

(54) Hybrid radio frequency transceiver

(76) Inventors: Ramamurthy Kumaresh, Singapore (SG); Ratchumari Srinivasa Rao, Singapore (SG); Somasundram S/O Palanisamy, Singapore (SG); NIXON NG HO KWONG, SINGAPORE (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/151,221

(22) Filed: May 17, 2002

(51) Int. Cl. H04B 1/04

(52) U.S. Cl. 455/118; 455/112

(57) ABSTRACT

A hybrid radio frequency transceiver using a single radio frequency transceiver able to send signals originating in at least two different frequency bands, wherein signals in a first frequency band are sent for transmission without conversion, and signals in all other frequency bands are converted to the first frequency band before being sent to the radio frequency transceiver. Also disclosed is a method for converting signals for a hybrid radio frequency transceiver using a single radio frequency transceiver able to send signals originating in at least two different frequency bands, wherein signals in a first frequency band are sent for transmission without conversion, and signals in all other frequency bands are converted to the first frequency band before being sent to the radio frequency transceiver.

### FIELD OF THE INVENTION

The present invention relates to a hybrid radio frequency transceiver and refers particularly, though not exclusively, to such a transceiver for receiving and converting signals of at least one frequency band to another frequency band.

### BACKGROUND OF THE INVENTION

Conventional transceivers such as very small aperture terminals (“VSAT”s) have been used for many years in voice and data applications. The data rate for them ranged from low to medium. Also, over the years radio frequency transceivers (“RFT”s) used in VSATs have been used with a 70/140 MHz intermediate frequency interface. Because of the Internet boom, data communication has become more prolific and, with this, the requirement for bandwidth has grown. Also, the VSAT market has become more consumer oriented rather than being solely for industrial purposes. This has resulted in pushes for substantial reduction of hardware cost.

With the increased demand for bandwidth, 70/140 MHz systems were changed to L band systems. Using the L band has the advantage of being able to use the entire 500 MHz bandwidth whereas, with the 70/140 MHz systems, one may be faced with only 36/72 MHz (one transponder) being available.

The difficulty faced by many customers was to introduce the L band systems into their network without discarding the existing 70/140 MHz systems. Even in the present broadband era, there are requirements for low data rate systems such as, for example, voice networks, supervisory applications, and network monitoring purposes. For these, the 70/140 MHz systems can be used.

The present solution is illustrated in FIG. 2. Here there are two separate systems that are combined at the antenna, which is the final stage. The main disadvantage of this system is that as the two systems are treated separately for most of the signal processing, there is a substantial cost increase due to duplication in hardware.

Normally all RFTs use dual conversion when converting 70/140 MHz to C band or Ku band. This means that the 70/140 MHz is first converted to L band and then to C or Ku band. This concept was used to split the unit into two.

It also involves substantial signal loss after the final stage, which is a direct result of an inefficient system. When the two systems are combined in this way there will be a minimum loss of 3 dB about half the power. This will result in higher power RFTs being needed, which will again increase the cost of the equipment. The reason for this is because RFTs in VSATs are a major part of the cost—normally about 30% of the construction cost.

### SUMMARY OF THE INVENTION

The present invention provides a hybrid radio frequency transceiver using a single radio frequency transceiver able to send signals originating in at least two different frequency bands, wherein signals in a first frequency band are sent for transmission without conversion, and signals in all other frequency bands are converted to the first frequency band before being sent to the radio frequency transceiver.

In a second form the present invention provides a hybrid radio frequency transceiver using a single radio frequency transceiver able to send signals originating in at least two different frequency bands, including signal processing means for passing signals in a first frequency band for transmission without conversion, the signal processing means also being for converting signals in all other frequency bands to the first frequency band and sending them to the radio frequency transceiver.

The signal processing means may be a converter.

In another form, the present invention provides a method for converting signals for a hybrid radio frequency transceiver using a single radio frequency transceiver able to send signals originating in at least two different frequency bands, wherein signals in a first frequency band are sent for transmission without conversion, and signals in all other frequency bands are converted to the first frequency band before being sent to the radio frequency transmitter.

For all three forms, there may be two frequency bands, the first band being the L band frequency band, and a second band, the second band being in the intermediate frequency range of 70/140±18/36 MHz and being converted to the first band. The conversion may be by an up/down converter that is also able to convert received signals from the first frequency range to the second frequency range. There may be provided an auxiliary port for signals in the first frequency band on both a receive and a transmit sides, and there may also be provided independent gain control for signals in the first frequency band. Dual conversion is preferably used to minimize spectral inversion. The converter may include a multiplexer for combining all signals in the first frequency band with a reference signal and a DC voltage signal. Furthermore, the converter may be set for a required frequency band for both the first band and the second band.

### DESCRIPTION OF THE DRAWINGS

In order that the invention may be readily understood and put into practical effect, there shall now be described by way of non-limitative example only a preferred embodiment of the present invention, the description being with reference to the accompanying illustrative drawings, in which:

FIG. 1 is a block diagram of the system of the present invention; and

FIG. 2 is a block diagram showing the prior art system presently in use.

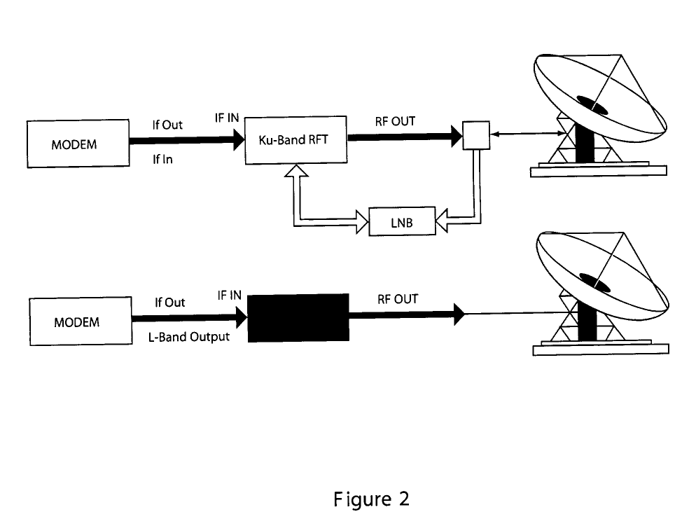

### DESCRIPTION OF THE PREFERRED EMBODIMENT

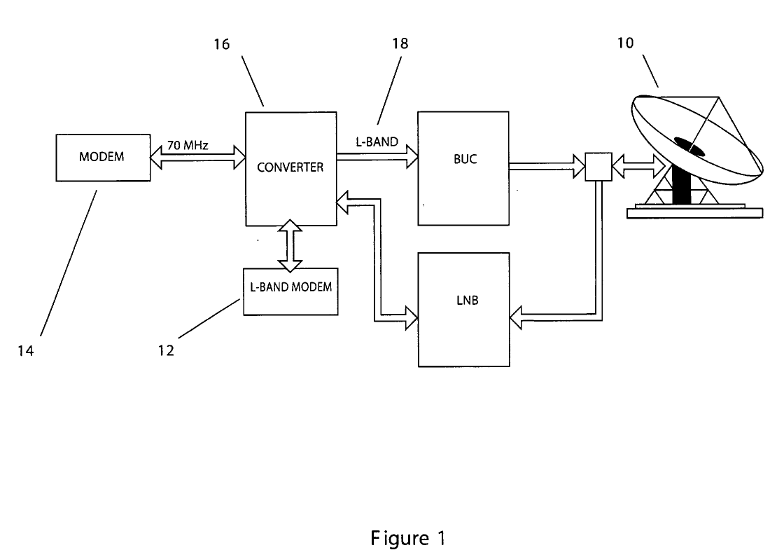

To refer to FIG. 1, there is shown a system having a single RFT 10 for both frequency band systems hence reducing the cost. In this system the L-band signals 12 in the range 950-1450 MHz and the intermediate frequency signals 14 in the range 70/140±18/36 MHz are both fed into a signal processing means such as a converter 16, which is before the RFT 10, and the output signals 18 of converter 16 are fed to the RFT 10 via a block up converter 20 and low noise block converter 22. The one RFT 10 transmits the signals irrespective of their original frequency range. With this system, the first conversion takes place indoors, while the second conversion is performed outdoors using the L band RFT.

The converter 16 converts the intermediate frequency range signals in the range 70/140±18/36 MHz, to L-band signals in the range 950-1450 MHz. It may be a rack mount up/down converter that is designed to provide a number of functions including a frequency conversion of intermediate frequency signals in the range 70/140±18/36 MHz, to L band signals in the range 950-1450 MHz. This is done on the transmit side. It also converts L band signals in the range 950-1450 MHz, to intermediate frequency signals in the range 70/140±18/36 MHz, on the receive side. In addition there is provided an auxiliary L band port 20 for connecting the L band system on both the transmit and receive sides There may also be independent gain control for the L band frequency range signals.

Up/down converter 16 can be effectively used with any L band outdoor equipment and provides a standard interface required for L band outdoor equipment. Up/down converter 16 can be controlled and monitored from a normal front control panel through a LCD, and soft keys for easy operation. It may have built-in test equipment to monitor the status of individual modules on the front panel display.

On the transmit side the up converter 16 provides frequency conversion from 70/140 MHz to the L band frequency range. Dual conversion is used to minimize spectral inversion. The L band, DC and the 10 MHz reference signal required for outdoor block up converters are multiplexed and provided at the transmit output. The equipment may be interfaced with either a C band or a Ku band RF outdoor unit.

The receive side takes L band input in the range 950-1450 MHz and down converts it to the intermediate frequency range 70/140±18/36 MHz. Again, the down conversion employs dual conversion to minimize spectral inversion. The receive chain may be interfaced with a C band or Ku band LNB. The L band RF input port may provide DC voltage and the 10 MHz reference required for the LNB.

Although the embodiment illustrated uses the intermediate frequency range of 70/140±18/36 MHz, and the L band frequency range of 950-1450 MHz, the up/down converter 16 may be able to be set for any required frequency. That adjustment ability may be in steps of 1 MHz, and may be through independent synthesizers. The units can be configured through the front panel LCD display through soft keys. The synthesizers may be referenced to a high frequency oven controlled 10 MHz reference oscillator. The stability of the oscillator is of the order of 10 exp. −9.

The transmit and receive levels of converter 16 may be controlled by digital attenuators that may provide a variation of 20 dB. The attenuators may be controlled from the front panel by use of the transmit and receive menus.

The auxiliary L band port 20 input may receive L band signals from the L band system. It may also have the facility to block the DC and 10 MHz signals emanating from the L band system. On the receive side, the converter 16 receives L band signals from the RFT and feeds it to the demodulator.

The L band converter 16 may also house a multiplexer both at the transmit and the receive side. The main function of the multiplexer is to combine the L band signal, the 10 MHz signal and the DC power, to be provided at a single port. On the transmit side the combined output can be fed into a C band or Ku band block up converter. On the receive side it may interface with a C or Ku band LNB to obtain intermediate frequency signals in the range 70/140±18/36 MHz.

By combining the signals of different frequency ranges at the L band stage reduces the cost over the previous system of where it is performed in the C or Ku band, which is expensive.

Also since the system involves a single L band RFT at the output, the number of components used is less as one stage is transferred indoors. This increases the reliability of the product.

Whilst there has been described in the foregoing description a preferred embodiment of the present invention, as will be understood by a person skilled in the technology, there may be many variations in details of design or construction without departing from the present invention.

The present invention extends to all features disclosed either individually or in all possible permutations and combinations.

1. A hybrid radio frequency transceiver using a single radio frequency transceiver able to send signals originating in at least two different frequency bands, wherein signals in a first frequency band are sent for transmission without conversion, and signals in all other frequency bands are converted to the first frequency band before being sent to the radio frequency transceiver.

2. A hybrid radio frequency VSAT as claimed in claim 1, wherein there are two frequency bands, the first band being the L band frequency band, and a second band.

3. A hybrid radio frequency VSAT as claimed in claim 2, wherein the second band is in the intermediate frequency range of 70/140±18/36 MHz.

4. A hybrid radio frequency VSAT as claimed in claim 2, wherein the second band is converted to the first band.

5. A hybrid radio frequency VSAT as claimed in claim 3, wherein the second band is converted to the first band.

6. A hybrid radio frequency VSAT as claimed in claim 2, wherein the conversion is by an up/down converter that is also able to convert received signals from the first frequency band to the second frequency band.

7. A hybrid radio frequency VSAT as claimed in claim 1, wherein there is provided an auxiliary port for signals in the first frequency band on both a receive and a transmit sides.

8. A hybrid radio frequency VSAT as claimed in claim 1, wherein there is provided independent gain control for signals in the first frequency band.

9. A hybrid radio frequency VSAT as claimed in claim 1, wherein dual conversion is used to minimize spectral inversion.

10. A hybrid radio frequency VSAT as claimed claim 6, wherein the up/down converter includes a multiplexer for combining all signals in the first frequency band with a reference signal and a DC voltage signal.

11. A hybrid radio frequency VSAT as claimed in claim 5, wherein the converter can be set for a required frequency band for both the first band and the second band.

12. A hybrid radio frequency VSAT as claimed in claim 9, wherein the converter can be set for a required frequency band for both the first band and the second band.

13. A method for converting signals for a hybrid radio frequency transceiver using a single radio frequency transceiver able to send signals originating in at least two different frequency bands, wherein signals in a first frequency band are sent for transmission without conversion, and signals in all other frequency bands are converted to the first frequency band before being sent to the radio frequency transceiver.

14. A method as claimed in claim 13, wherein there are two frequency bands, the first band being the L band frequency band, and a second band.

15. A method as claimed in claim 14, wherein the second band is in the intermediate frequency band of 70/140±18/36 MHz.

16. A method as claimed in claim 14, wherein the second band is converted to the first band.

17. A method as claimed in claim 13, wherein the conversion is by an up/down converter that is also converts received signals from the first frequency band to the second frequency band.

18. A method as claimed in claim 13, wherein there is provided an auxiliary port for signals in the first frequency band on both a receive side and a transmit side.

19. A method as claimed in claim 13, wherein there is provided independent gain control for signals in the first frequency band.

20. A method as claimed in claim 13, wherein dual conversion is used to minimize spectral inversion.

21. A method as claimed claim 17, wherein the converter includes a multiplexer for combining all signals in the first frequency band with a reference signal and a DC voltage signal.

22. A method as claimed in claim 16, wherein the converter is first set to a required frequency band for both the first frequency band and the second frequency band.

23. A method as claimed in claim 20, wherein the converter is first set to a required frequency range for both the first frequency range and the second frequency range.

24. A hybrid radio frequency transceiver using a single radio frequency transceiver able to send signals originating in at least two different frequency bands, including signal processing means for passing signals in a first frequency band for transmission without conversion, the signal processing means also being for converting signals in all other frequency bands to the first frequency band and sending them to the radio frequency transceiver.

25. A hybrid radio frequency VSAT as claimed in claim 24, wherein there are two frequency bands, the first band being the L band frequency band, and a second band.

26. A hybrid radio frequency VSAT as claimed in claim 25, wherein the second band is in the intermediate frequency range of 70/140±18/36 MHz.

27. A hybrid radio frequency VSAT as claimed in claim 25, wherein the second band is converted to the first band.

28. A hybrid radio frequency VSAT as claimed in claim 26, wherein the second band is converted to the first band.

29. A hybrid radio frequency VSAT as claimed in claim 25, wherein the signal processing means is an up/down converter that is also able to convert received signals from the first frequency band to the second frequency band.

30. A hybrid radio frequency VSAT as claimed in claim 24, wherein there is provided an auxiliary port for signals in the first frequency band on both a receive and a transmit sides.

31. A hybrid radio frequency VSAT as claimed in claim 24, wherein there is provided independent gain control for signals in the first frequency band.

32. A hybrid radio frequency VSAT as claimed in claim 24, wherein dual conversion is used to minimize spectral inversion.

33. A hybrid radio frequency VSAT as claimed claim 29, wherein the up/down converter includes a multiplexer for combining all signals in the first frequency band with a reference signal and a DC voltage signal.

34. A hybrid radio frequency VSAT as claimed in claim 28, wherein the signal processing means is able to be set for a required frequency band for both the first band and the second band.

35. A hybrid radio frequency VSAT as claimed in claim 32, wherein the signal processing means can be set for a required frequency band for both the first band and the second band.
